(19) United States
(12) Patent Application Publication
(10) Pub. No.: US 2020/0041030 A1
(43) Pub. Date: Feb. 6, 2020

(54) INFLATOR HEAD

(71) Applicant: Signode Industrial Group LLC, Glenview, IL (US)

(72) Inventors: Anthony K. Beard, Poyen, AR (US); Joseph W. Gault, Sheridan, AR (US)

(21) Appl. No.: 16/517,235

(22) Filed: Jul. 19, 2019

Related U.S. Application Data
(60) Provisional application No. 62/713,263, filed on Aug. 1, 2018.

(51) Int. Cl. F16K 31/44; B65D 81/05

(52) U.S. Cl. CPC F16K 31/44; B65D 81/052

(57) ABSTRACT

Various embodiments of the present disclosure provide an inflator head slidably mountable to a valve and configured to move the valve from a biased-closed configuration to an open configuration and to retain the valve in the open configuration.

### PRIORITY

This application claims priority to and the benefit of U.S. Provisional Patent Application No. 62/713,263, filed Aug. 1, 2018, the entire contents of which is incorporated herein by reference.

### FIELD

The present disclosure relates to inflator heads usable to direct pressurized air into inflatable objects, such as dunnage bags.

### BACKGROUND

Inflatable dunnage bags are used to stabilize and limit movement of cargo during transportation of cargo containers. Generally, after some or all of the cargo is loaded into a cargo container, uninflated dunnage bags are positioned in the voids between the cargo. The dunnage bags are then inflated to a desired pressure using pressurized air. The inflated dunnage bags fill the voids to limit movement of the cargo during transit.

### SUMMARY

Various embodiments of the present disclosure provide an inflator head slidably mountable to a valve and configured to move the valve from a biased-closed configuration to an open configuration and to retain the valve in the open configuration.

In various embodiments, the present disclosure provides an inflator head configured to be mounted to a valve, wherein the inflator head includes a valve holder including a bottom wall having a first side, a second side opposing the first side, a front end, and a rear end, wherein a valve-receiving opening defined in the bottom wall extends inward from an entrance defined in the first side of the bottom wall and terminates before reaching the second side; and a valve opener including a body and a head connected to the body, wherein the valve opener is pivotable relative to the valve holder between a mounting position and a valve-opening position, wherein the head of the valve opener is positioned over the valve-receiving opening when the valve opener is in the valve-opening position, wherein a gas passageway is defined through the valve opener.

In various other embodiments, the present disclosure provides an inflator head configured to be mounted to a valve, wherein the inflator head includes: a valve holder including a bottom wall having defining a valve-receiving opening having an entrance that extends inward from a first side of the bottom wall; and a valve opener pivotable relative to the valve holder between a mounting position and a valve-opening position, wherein the valve opener extends transversely to a direction in which the valve-receiving opening extends from the first side of the bottom wall.

### BRIEF DESCRIPTION OF THE FIGURES

FIG. 1 is a perspective view of one example embodiment of an inflator head of the present disclosure with the valve opener in a valve-opening position.

FIG. 2 is an exploded perspective view of the inflator head of FIG. 1.

FIGS. 3A and 3B are cross-sectional side-elevational views of the inflator head of FIG. 1 in the valve-opening and mounting positions, respectively, taken substantially along line 3A, 3B-3A, 3B of FIG. 1.

FIG. 4 is a perspective view of the valve holder of the inflator head of FIG. 1.

FIG. 5A is a perspective view of the valve opener of the inflator head of FIG. 1.

FIG. 5B is a side-elevational view of the valve opener of FIG. 5A.

FIG. 5C is a bottom-plan view of the valve opener of FIG. 5A.

FIG. 5D is a cross-sectional side-elevational view of part of the valve opener of FIG. 5A taken along line 5D-5D of FIG. 5C.

FIG. 5E is a cross-sectional top plan view of the valve opener of FIG. 5A taken substantially along line 5E-5E of FIG. 5B.

FIGS. 6A-6C are perspective views showing the process of mounting the inflator head of FIG. 1 to a valve.

FIG. 6D is a cross-sectional side-elevational view of the inflator head of FIG. 1 mounted to the valve of FIGS. 6A-6C taken substantially along line 6D-6D of FIG. 6C.

### DETAILED DESCRIPTION

While the systems, devices, and methods described herein may be embodied in various forms, the drawings show and the specification describes certain exemplary and non-limiting embodiments. Not all of the components shown in the drawings and described in the specification may be required, and certain implementations may include additional, different, or fewer components. Variations in the arrangement and type of the components; the shapes, sizes, and materials of the components; and the manners of connections of the components may be made without departing from the spirit or scope of the claims. Unless otherwise indicated, any directions referred to in the specification reflect the orientations of the components shown in the corresponding drawings and do not limit the scope of the present disclosure. Further, terms that refer to mounting methods, such as coupled, mounted, connected, etc., are not intended to be limited to direct mounting methods but should be interpreted broadly to include indirect and operably coupled, mounted, connected and like mounting methods. This specification is intended to be taken as a whole and interpreted in accordance with the principles of the present disclosure and as understood by one of ordinary skill in the art.

Various embodiments of the present disclosure provide an inflator head slidably mountable to a valve and configured to move the valve from a biased-closed configuration to an open configuration and to retain the valve in the open configuration. In this example embodiment the valve is referred to as being attached to (and usable to inflate or deflate) a dunnage bag (not shown), though the valve may be attached to (and usable to inflate or deflate) any suitable inflatable object, such as (but not limited to) other types of inflatable bags, air mattresses, rafts, and tires.

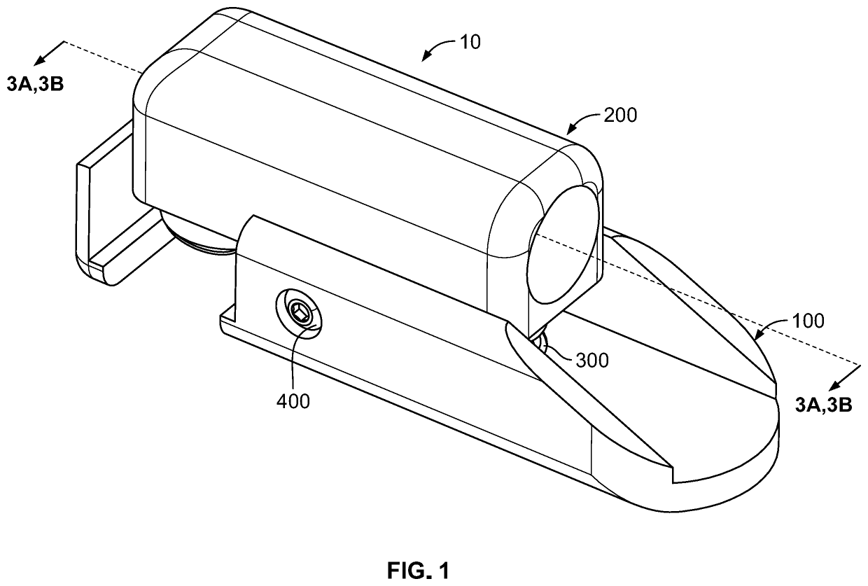

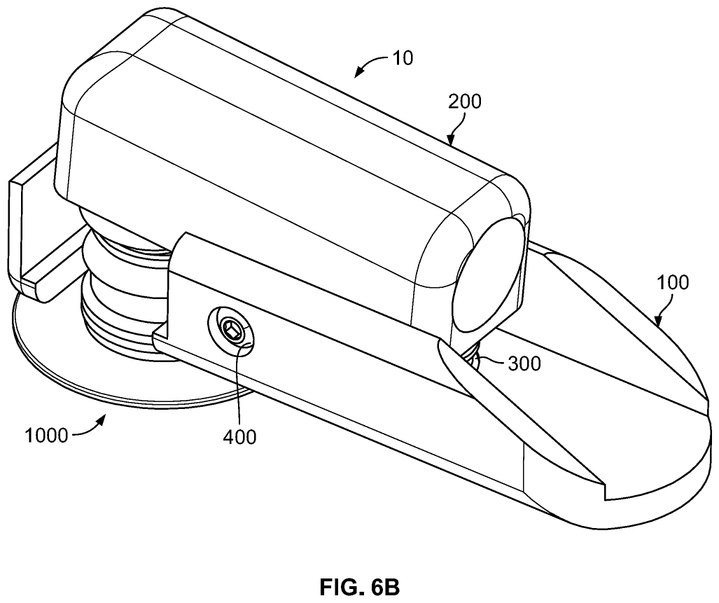

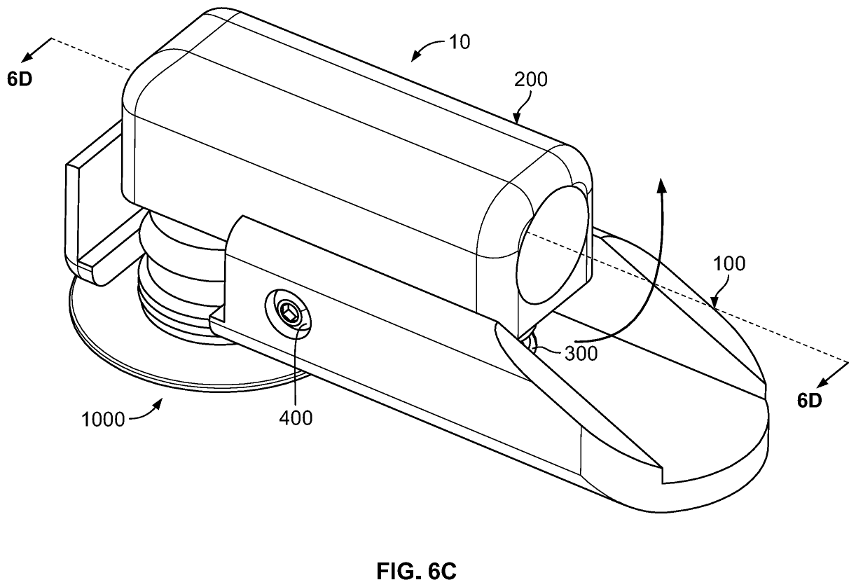

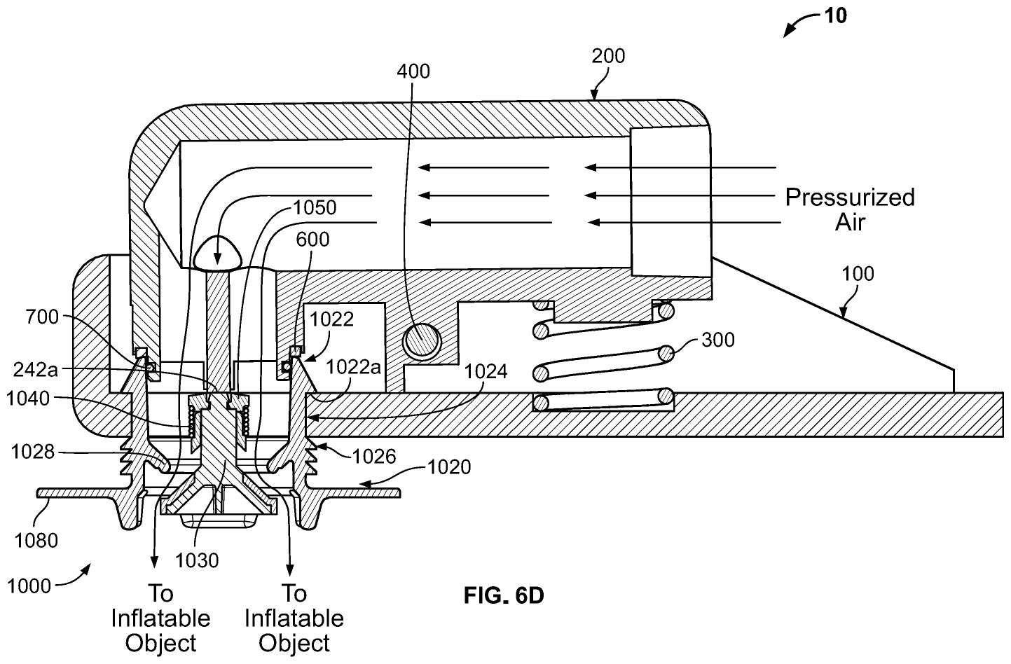

FIGS. 1-5E show one embodiment of the inflator head 10 of the present disclosure and the components thereof. FIGS. 6A-6D show how the inflator head 10 slidably mounts to an example valve 1000 (though any suitable valve may be employed). As best shown in FIGS. 1-3B, the inflator head 10 includes a valve holder 100; a valve opener 200; a biasing element 300 (here, a compression spring); a pivot 400 (here, a threaded bolt); a pivot securer 500 (here, a nut threadable onto the threaded bolt); a first sealing element 600 (here, an O-ring with a rectangular cross-section); and a second sealing element 700 (here, an O-ring with a circular cross-section).

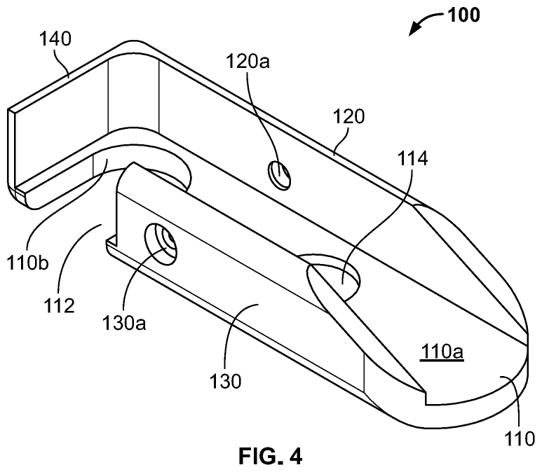

As best shown in FIG. 4, the valve holder 100 includes a bottom wall 110, a first side wall 120 connected to (such as integrally formed with) and extending transverse (such as perpendicular) to a first side of the bottom wall 110, a second side wall 130 connected to (such as integrally formed with) and extending transverse (such as perpendicular) to a second side of the bottom wall 110 opposite the first side wall 120, and a front wall 140 connected to (such as integrally formed with) and extending transverse (such as perpendicular) to a front end of the bottom wall 110 and the first side wall 120. The first and second sides of the bottom wall 110 are approximately the same length, and are longer than the front end of the bottom wall 110 is wide.

The bottom wall 110 defines a valve-receiving opening 112 that extends inward from an entrance defined in the second side of the bottom wall 110 to which the second side wall 130 (and in alternative embodiments the first side wall 120) is connected and terminates before reaching the first side of the bottom wall 110 to which the first side wall 120 (and in alternative embodiments the second side wall 130) is connected. The valve-receiving opening 112 is sized, shaped, positioned, and otherwise configured to receive and support part of the valve 1000, as explained below. The second side wall 130 and the front wall 140 are spaced apart near the entrance to the valve-receiving opening 112 to enable insertion of the valve 1000 into the valve-receiving opening 112 from the side of the inflator head 10. The bottom wall 110 also defines a first biasing-element retainer 114 in the form of a recess that is sized and shaped to receive and retain one end of the biasing element 300, as described below. In other embodiments, the first biasing-element retainer includes a projection (such as a cylindrical projection) that is sized, shaped, positioned, and otherwise configured to be circumscribed by one end of the biasing element to retain the biasing element in plate.

The first and second side walls 120 and 130 define respective pivot-receiving openings 120a and 130a therethrough. The pivot-receiving openings 120a and 130a are coaxial and sized to receive the pivot 400 to pivotably mount the valve opener 200 to the valve holder 100, as explained below.

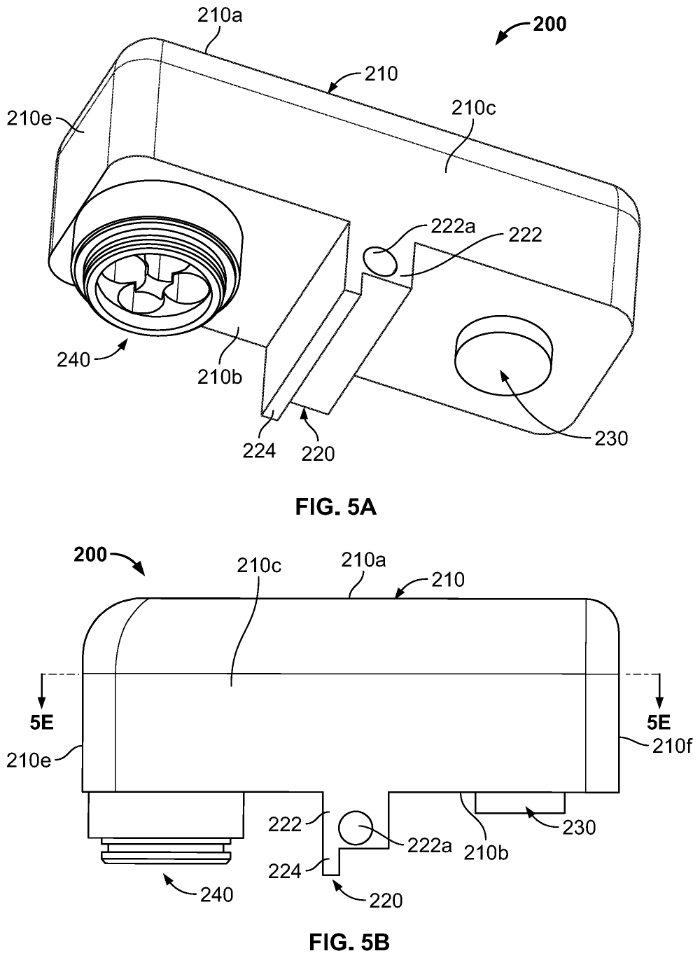

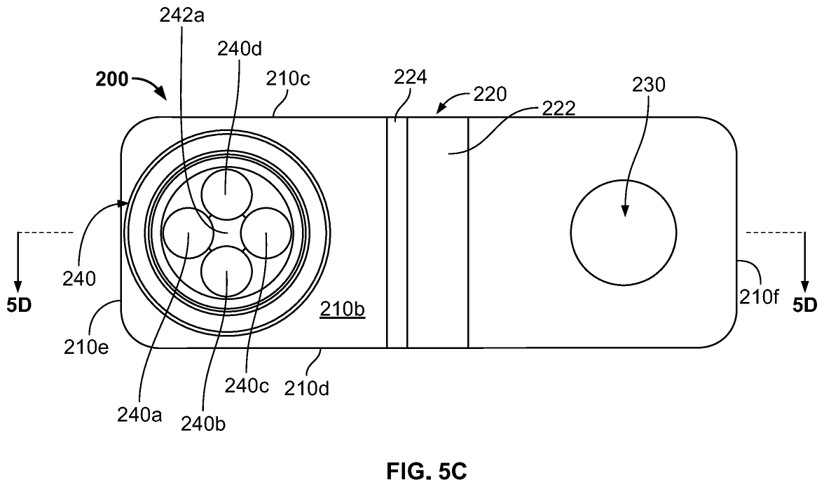

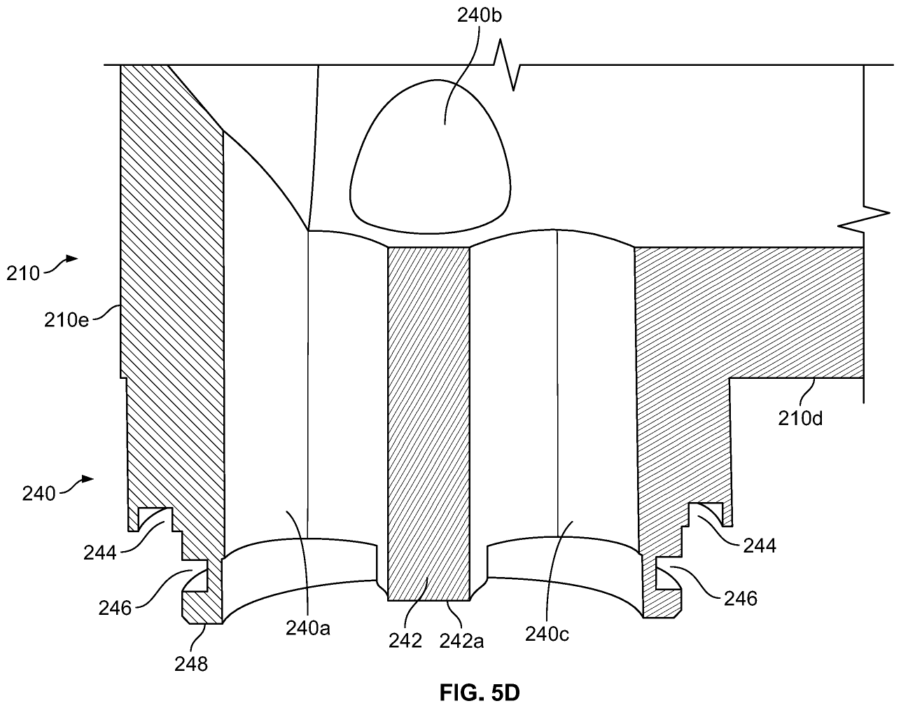

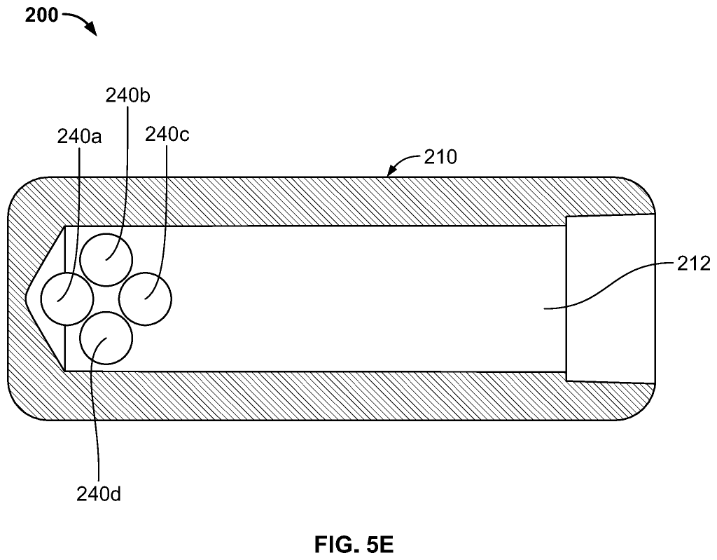

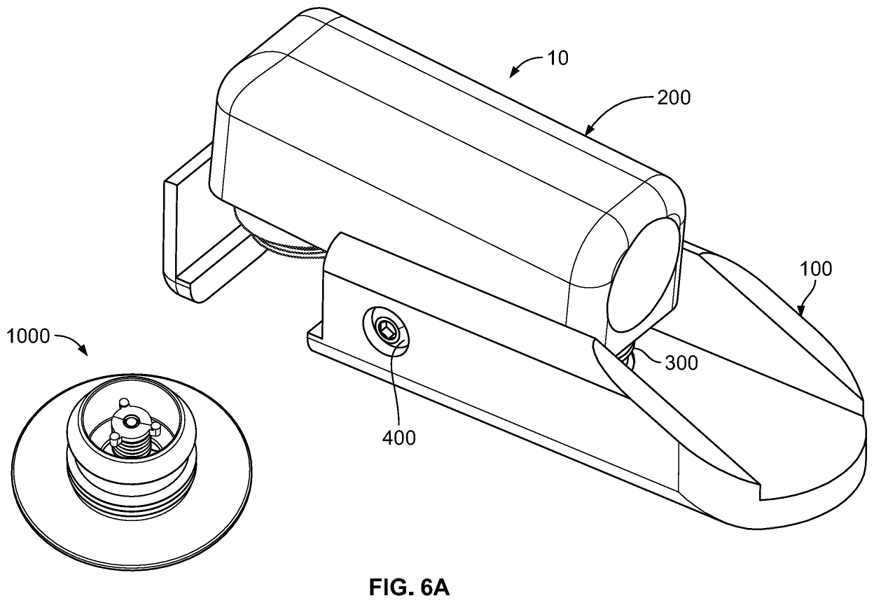

As best shown in FIGS. 5A-5E, the valve opener 200 includes a body 210, a mount 220, a second biasing-element retainer 230, and a head 240.

The body 210 is a generally rectangular parallelepiped having an upper surface 210a, a lower surface 210b opposing the upper surface 210a, a first side surface 210c, a second side surface 210d opposing the first side surface 210c, a front surface 210e, and a rear surface 210f opposing the front surface 210e. As best shown in FIG. 5E, a cylindrical bore 212 extends from the rear surface 210f toward the front surface 210e and terminates within the body 210 adjacent the head 240. As described below, the bore 212 forms part of a gas passageway defined through the valve opener 200. Although not shown here, the body 210 is configured to be connected to a pressurized air delivery implement to fluidly connect the pressurized air source with the gas passageway. For instance, the body 210 may include a quick-connect (or a threaded) adapter connected to the rear surface 210f and configured to couple with a corresponding quick-connect (or a threaded) adapter of a pressurized air hose to fluidly connect the pressurized air source with the gas passageway.

The mount 220 is connected to (here, integrally formed with) and extends from the lower surface 210b of the body 210. The mount 220 includes a mount base 222 connected to (here, integrally formed with) the lower surface 210b of the body 210 and a mount foot 224 connected to and extending from the mount base 222. A mounting opening 222a (here, a cylindrical bore) is defined through the mount base 222. The mounting opening 222a is sized to receive the pivot 400 to mount the valve opener 200 to the valve holder 100, as described below.

The second biasing-element retainer 230 is connected to (here, integrally formed with) and extends from the lower surface 210b of the body 210. The second biasing-element retainer 230 is sized to be circumscribed by an upper end of the biasing element 300 to retain the biasing element 300 in place, as explained below.

As best shown in FIG. 5D, the head 240 includes a generally cylindrical body connected to (here, integrally formed with) and extending from the lower surface 210b of the body 210 and terminating at a free end 248. About its outer periphery and near its free end 248, the head 240 defines an annular first sealing-element-receiving channel 244 sized, shaped, positioned, and otherwise configured to receive and retain (via interference fit) the first sealing element 600 and an annular second sealing-element-receiving channel 246 sized, shaped, and otherwise configured to receive and retain (via interference fit) the second sealing element 700. In this example embodiment, the first sealing element 600 has a larger radius than the second sealing element 700.

Four circumferentially spaced, axially extending, and generally parallel bores 240a-240d are defined in the head 240. The bores 240a-240d extend from the free end 248 of the head 240 toward the body 210 and terminate at the bore 212 defined in the body 210 so the bore 212 and the bores 240a-240d are in fluid communication. The bores 212 and 240a-240d together define a gas passageway through the valve opener 200 that extends between the rear surface 210f of the body 210 and the free end 248 of the head 240. This is merely one example configuration of bores that define the gas passageway, and the gas passageway may be formed in any other suitable manner and take any other suitable shape in other embodiments. The head 240 also includes a valve engager 242 centered between the bores 240a-240d and generally aligned with a longitudinal axis of the head 240. The valve engager 242 has a valve-engaging surface 242a at its lower end.

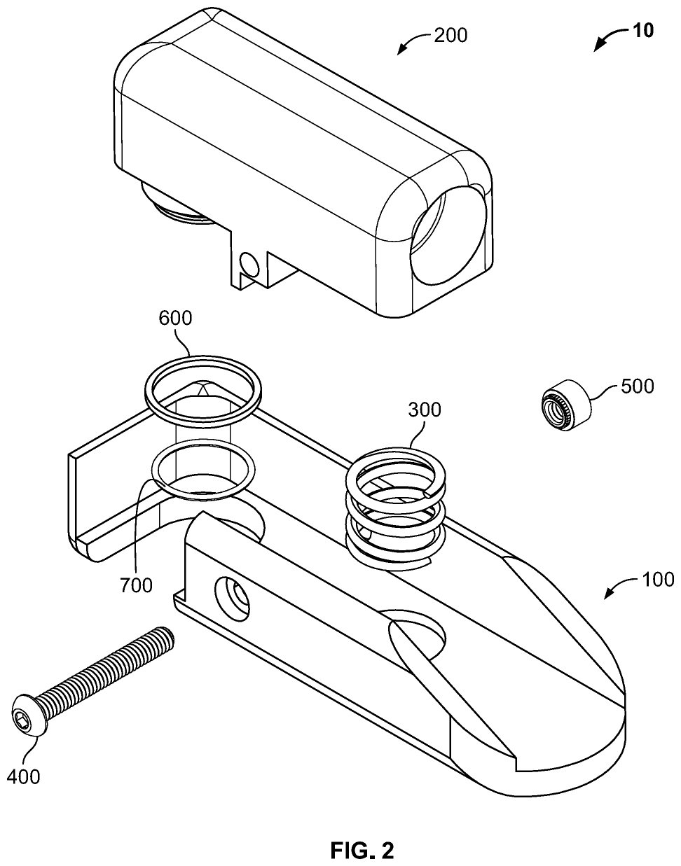

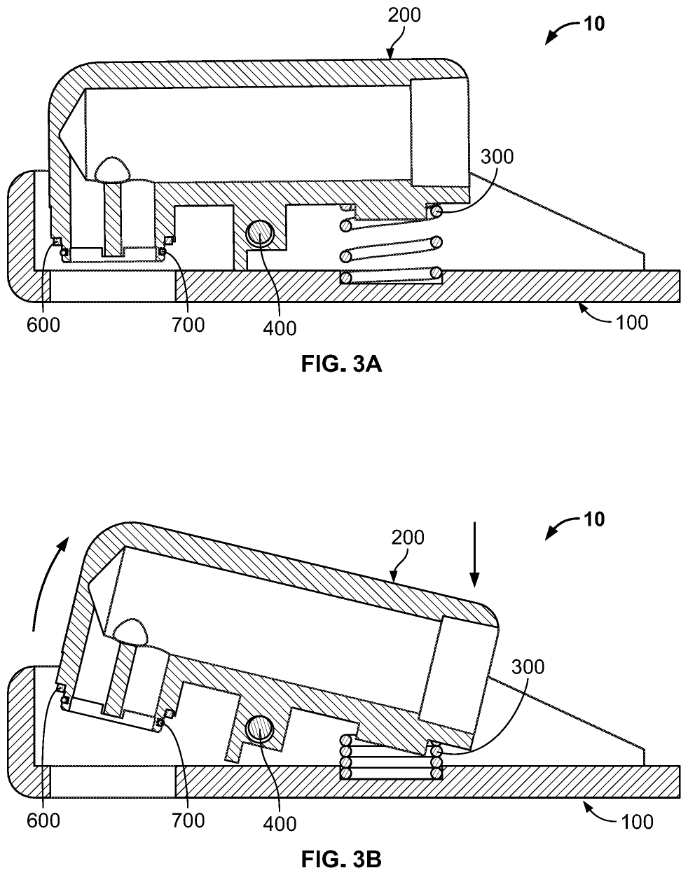

To assemble the inflator head 10, as best shown in FIGS. 2 and 3A, the valve opener 200 is pivotably mounted to the valve holder 100 by: (1) positioning the valve opener 200 between the first and second side walls 120 and 130 of the valve holder 100 such that the mounting opening 222a of the mount 220 of the valve opener 200 is aligned with the pivot-receiving openings 120a and 130a of the first and second side walls 120 and 130; (2) inserting the pivot 400 through the pivot-receiving opening 120a in the first side wall 120 of the valve holder 100, through the mounting opening 222a of the mount 220 of the valve opener 200, and through the pivot-receiving opening 130a in the second side wall 130 of the valve holder 100; and (3) securing the pivot 400 in place using the pivot securer 500 (such as by threading the pivot securer onto the end of the pivot extending from the pivot-receiving opening in the second side wall).

A lower end of the biasing element 300 is inserted into the first biasing-element retainer 114 of the bottom wall 110 of the valve holder 100. An upper end of the biasing element 300 is positioned to circumscribe the second biasing-element retainer 230 of the valve opener 200. These elements in combination retain the biasing element 300 in place between the base and valve openers 100 and 200. This may be done before the pivot is secured in place in other embodiments.

The valve opener 200 is pivotable relative to the valve holder 100 between a valve-opening position (FIG. 3A) and a mounting position (FIG. 3B). The biasing element 300 biases the valve opener 200 to the valve-opening position. To pivot the valve opener 200 to the mounting position, a user pushes the rear end of the valve opener 200 toward the bottom wall 110 of the valve holder 100 with enough force to overcome the biasing force of the biasing element 300.

As best shown in FIG. 6D, the valve 1000 includes a valve body 1020, a valve stem 1030, a spring 1040, a spring retainer 1050, and a mounting flange 1080. The valve body 1020 is generally tubular and includes a head 1022, multiple ribs 1026 axially spaced-apart from the head 1022, a mounting portion 1024 axially between the head 1022 and the ribs 1026, and a radially inwardly and axially downwardly extending inner wall 1028. The head 1022 is tapered axially downwardly and radially outwardly and has an annular underside 1022a. The ribs 1026 are also tapered axially downwardly and radially outwardly.

The valve stem 1030 is biasedly mounted to the valve body 1020 via the spring 1040, which is retained in place on the valve body 1020 by the spring retainer 1050 connected to a top of the valve stem 1030. The spring 1040 biases the valve stem 1030 to a closed position (not shown) in which a sealing element (not labeled) of the valve stem 1030 sealingly engages the inner wall 1028 to prevent gas from flowing through the valve 1000 into or out of the dunnage bag. The valve stem 1030 is movable from the closed position to an open position, which is shown in FIG. 6D, to remove the sealing element from the inner wall 1028 and therefore enable gas to flow through the valve 1000 into or out of the dunnage bag.

FIGS. 6A-6D show the process of mounting the inflator head 10 to the valve 1000. As shown in FIG. 6A, the user pivots the valve opener 200 of the inflator head 10 to the mounting position and positions the inflator head 10 so the valve 1000 is adjacent the entrance to the valve-receiving opening 112 on the side of the inflator head 10. While maintaining the valve opener 200 in the mounting position, the user slides the inflator head 10 from the side onto the valve 1000 such that: (1) the mounting portion 1024 of the valve body 1020 is received in the valve-receiving opening 112 such that the bottom wall 110 is positioned between the ribs 1026 and the underside 1022a of the head 1022 of the valve 1000; and (2) the valve-engaging surface 242a of the valve engager 242 of the head 240 of the valve opener 200 is adjacent the top of the valve stem 230, as shown in FIGS. 6B and 6D. The fact that the inflator head 10 receives the valve 1000 from the side is an improvement over existing inflator head designs because it retains the inflator head more securely on the valve when a moment is applied to the inflator head. For instance, once the inflator head is mounted to the valve, if the user accidentally pulls upward on the rear end of the inflator head the inflator head is not likely to disengage the valve such that air leaks from the inflator head/valve interface.

The user then releases the valve opener 200. This causes the biasing element 300 to bias the valve opener 200 back to the valve-opening position. As this occurs: (1) the valve-engaging surface 242a engages the top of the valve stem 1030 and forces the valve stem 1030 to move from its closed position to its open position; (2) the first sealing element 600 sealingly engages an annular top surface of the head 1022 of the valve 1000; and (3) the second sealing element 700 sealingly engages an inner cylindrical surface of the valve body 1020 of the valve 1000. At this point, the valve 1000 fluidly connects the gas passageway of the valve opener 200 of the inflator head 10 to the interior of the dunnage bag. The use of two sealing elements introduces redundancy so if one of the sealing element fails the other continues to sealingly engage the valve and ensure air does not leak through the inflator head/valve interface.

To inflate the dunnage bag, a user fluidly connects a pressurized gas source to the gas passageway, such as by connecting a pressurized air hose to the body 210 of the valve opener 200. The user then introduces pressurized gas from the pressurized gas source into the gas passageway. The gas travels through the gas passageway to the valve 1000 and travels through the valve 1000 and into the dunnage bag to begin inflating the dunnage bag. During inflation the first and second sealing elements 600 and 700 prevent gas from leaking from the inflator head/valve interface. Once the pressure of the gas within the dunnage bag reaches a desired pressure, the user stops the flow of pressurized gas and removes the inflator head 10 from the valve 1000. Removal of the valve-engaging surface 242a from the valve stem 1030 (via rotation of the valve opener 200 back to the mounting position) causes the spring 1040 to bias the valve stem 1030 back to the closed position, which prevents the gas from escaping the dunnage bag through the valve 1000.

To deflate the dunnage bag, the user again mounts the inflator head 10 to the dunnage bag 1000, but without connecting the inflator head 10 to a pressurized gas source. Once the valve stem 1030 is in the open position, gas will begin to flow from the dunnage bag through the valve 1000 and into the gas passageway, and through the gas passageway to the atmosphere, thereby deflating the dunnage bag.

In other embodiments, the valve opener is biased to the mounting position and must be held in the valve-opening position to inflate (or deflate) the dunnage bag. In certain such embodiments, the inflator head includes a locking device sized, shaped, positioned, and otherwise configured to lock the valve opener in the valve-open position.

In other embodiments, the inflator head includes one of the two above-described sealing elements.

1. An inflator head configured to be mounted to a valve, the inflator head comprising:
a valve holder comprising a bottom wall having a first side, a second side opposing the first side, a front end, and a rear end, wherein a valve-receiving opening defined in the bottom wall extends inward from an entrance defined in the first side of the bottom wall and terminates before reaching the second side; and
a valve opener comprising a body and a head connected to the body, wherein the valve opener is pivotable relative to the valve holder between a mounting position and a valve-opening position, wherein the head of the valve opener is positioned over the valve-receiving opening when the valve opener is in the valve-opening position, wherein a gas passageway is defined through the valve opener.

2. The inflator head of claim 1, wherein the valve holder comprises a first side wall connected to the first side of the bottom wall and a second side wall connected to the second side of the bottom wall, wherein the inflator head further comprises a pivot extending between the first and second side walls, wherein the valve opener is mounted the pivot.

3. The inflator head of claim 1, wherein the body of the valve opener is configured to be attached to a pressurized-gas-providing implement.

4. The inflator head of claim 3, wherein the gas passageway extends from a rear surface of the body of the valve opener through the head of the valve opener.

5. The inflator head of claim 4, wherein the gas passageway comprises a first portion defined in the body of the valve opener and multiple second portions defined in the head of the valve opener.

6. The inflator head of claim 5, wherein the second portions defined in the head of the valve opener are transverse to the first portion defined in the body of the valve opener.

7. The inflator head of claim 1, wherein when the inflator head is mounted to the valve, movement of the valve opener from the mounting position to the valve-opening position causes the valve to open.

8. The inflator head of claim 7, wherein when the inflator head is mounted to the valve, movement of the valve opener from the mounting position to the valve-opening position causes the head to directly contact part of the valve to open the valve.

9. The inflator head of claim 8, wherein the valve remains open so long as the valve opener remains in the valve-opening position.

10. The inflator head of claim 1, wherein when the valve opener is in the valve-open position, the head is positioned to prevent the valve from entering the valve-receiving opening.

11. The inflator head of claim 1, further comprising a first sealing element mounted to the head of the valve opener, the first sealing element sealingly engaging a first portion of the valve when the inflator head is mounted to the valve and the valve opener is in the valve-opening position.

12. The inflator head of claim 11, further comprising a second sealing element mounted to the head of the valve opener, the second sealing element sealingly engaging a second portion of the valve different from the first portion of the valve when the inflator head is mounted to the valve and the valve opener is in the valve-opening position.

13. The inflator head of claim 1, further comprising distinct first and second O-rings mounted to the head of the valve opener and positioned to sealingly engage the valve.

14. The inflator head of claim 1, wherein the first side is longer than the front end is wide.

15. The inflator head of claim 1, further comprising a biasing element biasing the valve opener to the valve-opening position.

16. An inflator head configured to be mounted to a valve, the inflator head comprising:
a valve holder comprising a bottom wall having defining a valve-receiving opening having an entrance that extends inward from a first side of the bottom wall; and
a valve opener pivotable relative to the valve holder between a mounting position and a valve-opening position, wherein the valve opener extends transversely to a direction in which the valve-receiving opening extends from the first side of the bottom wall.
